(19) United States
(12) Patent Application Publication
(10) Pub. No.: US 2026/0365837 A1
(43) Pub. Date: Nov. 19, 2026

(54) COMPOSITION OF THERMOPLASTIC ELASTOMER

(71) Applicants: Hyundai Motor Company, Seoul (KR); Kia Corporation, Seoul (KR); CEPLA Co., Ltd., Asan (KR); Hyundai Mobis Co., Ltd., Seoul (KR)

(72) Inventors: In Soo Han, Hwaseong (KR); Jae Hyun An, Hwaseong (KR); Eun Ju Noh, Hwaseong (KR); Kyu Haeng Cho, Chungcheongnam-do (KR); Dae Up Ahn, Pyeongtaek (KR); Chang Won Chae, Seoul (KR); Yu Su Han, Gunpo (KR); Chang Min Hong, Anyang (KR); Do Hyung Kim, Seoul (KR); Sang Phil Park, Seoul (KR)

(21) Appl. No.: 19/408,244

(22) Filed: Dec. 3, 2025

(30) Foreign Application Priority Data
May 13, 2025 (KR) 10-2025-0062143

(51) Int. Cl. C08L 23/12; B60R 21/235

(52) U.S. Cl. CPC C08L 23/12; B60R 2021/23504; C08L 2205/035; C08L 2207/04

(57) ABSTRACT

Disclosed is a polyolefin-based thermoplastic elastomer composition optimized for molding airbag chutes. The composition contains a polypropylene resin in content ranging from 40 wt % to 60 wt %, an olefin block copolymer in content ranging from 20 wt % to 50 wt %, and a polyolefin plastomer in content ranging from 5 wt % to 30 wt %. By adjusting these components within the specified ranges, the material achieves a unique balance of high melt flow for easy processing, excellent tensile strength and impact resistance for durability, and reduced shrinkage for improved dimensional stability. The olefin block copolymer and the plastomer work in synergy with polypropylene. The resulting composition is lightweight and capable of maintaining its shape and mechanical integrity, making it highly suitable for safety components like vehicle airbag chute housings.

### CROSS-REFERENCE TO RELATED APPLICATION

This application claims under 35 U.S.C. § 119(a) the benefit of Korean Patent Application No. 10-2025-0062143, filed in the Korean Intellectual Property Office on May 13, 2025, the entire contents of which are incorporated herein by reference.

### BACKGROUND

### Technical Field

The present disclosure relates to a composition of thermoplastic elastomer, and more particularly, relates to a composition of thermoplastic elastomer based on polyolefin for a chute of an airbag.

### Background

In general, an airbag device is mounted in a vehicle for the safety of an occupant. Among airbag devices, a passenger air bag (PAB) is a device to protect a passenger on a passenger seat.

A chute, which is a device to fix the passenger airbag, has a space to receive an airbag, which is folded. In addition, the chute is a device to withstand higher pressure when the passenger airbag is deployed. The chute needs to withstand higher deploying pressure, when the passenger airbag is deployed. Accordingly, the chute typically includes thermoplastic olefin.

A door is provided in an opening part of the chute and is open when the airbag is inflated, and a scrim is interposed between the chute and the door to couple one side of the chute to a door part, such that the door part is pivoted. However, as the scrim is applied, the content of the thermoplastic olefin is increased such that the dimension of the chute may fail to be stably maintained (dimensional stability may be degraded).

### SUMMARY

At least some embodiments of the present disclosure have been made to solve the above-mentioned problems occurring in the existing technologies while advantages achieved by the existing technologies are maintained intact.

Some embodiments of the present disclosure provide a composition of thermoplastic elastomer formulated with an olefin-based plastomer, which simultaneously satisfies an excellent melt index, an excellent tensile property, and an excellent impact strength, while exhibiting a lower shrinkage rate.

Some embodiments of the present disclosure provide an airbag chute including a composition of thermoplastic elastomer including an olefin-based plastomer having a lower density.

The technical problems to be solved by the present disclosure are not limited to the aforementioned problems, and any other technical problems not mentioned herein will be clearly understood from the following description by those skilled in the art to which the present disclosure pertains.
(1) The present disclosure provides a composition of thermoplastic elastomer which includes a polypropylene resin in content ranging from 40 wt % to 70 wt %, an olefin block copolymer in content ranging from 15 wt % to 50 wt %, and a polyolefin plastomer in content ranging from 5 wt % to 30 wt %.
(2) The present disclosure provides a composition of thermoplastic elastomer in which the polypropylene resin includes first polypropylene resin having a melt index (measured at a condition of 230 °C and a 2.16 kg load) ranging from 5 g/10 min to 40 g/10 min, and second polypropylene resin having a melt index (measured under a condition of 230 °C and a 2.16 kg load) ranging from 50 g/10 min to 80 g/10 min, in (1).
(3) The present disclosure provides a composition of thermoplastic elastomer in which the first polypropylene resin has a content ranging from 40 wt % to 70 wt %, and the second polypropylene resin has a content ranging from 0 wt % to 20 wt %, in (1) or (2).
(4) The present disclosure provides a composition of thermoplastic elastomer in which the olefin block copolymer has a melt index (measured under a condition of 190 °C and a 2.16 kg load) ranging from 0.5 g/10 min to 5 g/10 min, in any one of (1) to (3).
(5) The present disclosure provides a composition of thermoplastic elastomer in which the olefin block copolymer has a density of at most 0.87 g/cm³, in any one of (1) to (4).
(6) The present disclosure provides a composition of thermoplastic elastomer in which the olefin block copolymer includes ethylene and alpha-olefin polymers, in any one of (1) to (5).
(7) The present disclosure provides a composition of thermoplastic elastomer in which the alpha-olefin may have 4 to 10 carbon atoms, in any one of (1) to (3).
(8) The present disclosure provides a composition of thermoplastic elastomer in which the polyolefin plastomer has a density of at least 0.885 g/cm³, in any one of (1) to (7).
(9) The present disclosure provides a composition of thermoplastic elastomer in which the polyolefin plastomer has a melt index (measured under a condition of 230 °C and a 2.16 kg load) ranging from 0.5 g/10 min to 8 g/10 min, in any one of (1) to (8).
(10) The present disclosure provides a composition of thermoplastic elastomer in which the polyolefin plastomer is produced through gas-phase polymerization, in any one of (1) to (9).
(11) The present disclosure provides a composition of thermoplastic elastomer in which a total content of the olefin block copolymer and the polyolefin plastomer ranges from 30 wt % to 60 wt %, in any one of (1) to (10).
(12) The present disclosure provides an airbag chute including the composition of thermoplastic elastomer in any one of (1) to (11).

In Some embodiments, provided is a thermoplastic elastomer composition comprising: a first polypropylene resin in an amount ranging from 40 wt % to 70 wt % and having a melt index ranging from 5 g/10 min to 40 g/10 min, measured at 230 °C under a 2.16 kg load; a second polypropylene resin in an amount ranging from 1 wt % to 20 wt % and having a melt index ranging from 50 g/10 min to 80 g/10 min, measured at 230 °C under a 2.16 kg load; an olefin block copolymer in an amount ranging from 15 wt % to 50 wt % to having a density of at most 0.87 g/cm3; and a polyolefin plastomer in an amount ranging from 5 wt % to 30 wt % and having a density of at least 0.885 g/cm3, wherein the olefin block copolymer and the polyolefin plastomer are present in an amount ranging from 30 wt % to 60 wt %.

The olefin block copolymer may have a melt index ranging from 0.5 g/10 min to 5 g/10 min, measured at 190 °C under a 2.16 kg load.

The polyolefin plastomer may have a melt index ranging from 0.5 g/10 min to 5 g/10 min, measured at 190 °C under a 2.16 kg load.

The polyolefin plastomer may be produced by gas-phase polymerization.

The olefin block copolymer may be a copolymer of ethylene and an alpha-olefin.

The alpha-olefin may have 4-10 carbon atoms.

The first polypropylene resin may be present in an amount from 45 wt % to to 65 wt %.

The second polypropylene resin may be present in an amount from 5 wt % to 15 wt %.

In another embodiment, vehicles are provided that comprise an apparatus as disclosed herein.

### DETAILED DESCRIPTION

Hereinafter, the present disclosure will be described in more detail for the understanding of the present disclosure.

For example, terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “thermoplastic elastomer composition” as used herein refers to a polymer blend that behaves like rubber at use temperatures (elastic and flexible) but can be processed and re-melted like a thermoplastic. In this context, the thermoplastic elastomer composition is primarily a blend of polyolefin materials that provides rubber-like elasticity along with thermal plasticity for molding.

The term “polypropylene resin” as used herein refers to any polymer comprising propylene monomer units, including propylene homopolymers and propylene copolymers.

The term “olefin block copolymer as used herein refers to a multi-block copolymer composed of olefin monomers, typically comprising blocks of differing comonomer composition.

The term “polyolefin plastomer” as used herein refers to a subclass of polyolefin copolymers that are semi-crystalline and elastomeric.

The term “alpha-olefin” as used herein refers to an olefin (alkene) monomer with the formula CₙH₂ₙ, where the double bond is at the first (alpha) carbon.

### <Composition of Thermoplastic Elastomer>

The present disclosure provides a composition of thermoplastic elastomer, and more particularly, provides a composition of thermoplastic elastomer for an airbag chute.

According to an embodiment of the present disclosure, the composition of thermoplastic elastomer may include polyolefin resin ranging from 40 wt % to 70 wt %, olefin-based block copolymer ranging from 20 wt % to 50 wt %, and a polyolefin plastomer ranging from 5 wt % to 20 wt %.

The inventors of the present disclosure find out that the composition of thermoplastic elastomer exhibits an excellent melt index, an excellent tensile property, and an excellent impact strength while exhibiting the lower shrinkage rate by properly adjusting the content of the polyolefin resin, the olefin-based block copolymer, and the polyolefin plastomer.

According to an embodiment of the present disclosure, the melt index, which was measured for the composition of thermoplastic elastomer under the condition of 230 °C and a 2.16 kg load in compliance with ISO 1133, may be 10 g/10 min. Specifically, the melt index for the composition of thermoplastic elastomer may be at least 10.5 g/10 min, at least 11 g/10 min, at least 11.5 g/10 min, at least 12 g/10 min, at least 12.5 g/10 min, or at least 13 g/10 min. When the above range is satisfied, the composition of thermoplastic elastomer may be evaluated as having an excellent melt index.

According to an embodiment of the present disclosure, the tensile strength, which was measured for the composition of thermoplastic elastomer under the condition of the tensile rate of 50 mm/min in compliance with ISO 527, may be at least 12.5 MPa, and the tensile elongation may be at least 400%. Specifically, the tensile strength may be at least 12.6 MPa, at least 12.8 MPa, at least 13 MPa, at least 13.2 MPa, at least 13.4 MPa, or at least 13.6 MPa, and the tensile elongation may be at least 410%, at least 420%, at least 430%, at least 440%, or at least 450%. When the above range is satisfied, the tensile property of the composition of thermoplastic elastomer may be evaluated as having an excellent tensile property.

According to an embodiment of the present disclosure, the impact strength, which was measured for the composition of thermoplastic elastomer under the condition of a normal temperature (25 °C) through an IZOD manner in compliance with ISO 179, may be at least 50 KJ/m². The impact strength, which was measured for the composition of thermoplastic elastomer under the condition of a lower temperature (−30 °C), may be at least 55 KJ/m². Specifically, the impact strength, which was measured for the composition of thermoplastic elastomer under the condition of a normal temperature (25 °C), may be at least 50.5 kJ/m², at least 51 kJ/m², at least 51.5 kJ/m², at least 52 kJ/m², or at least 52.5 kJ/m², and the impact strength, which was measured for the composition of thermoplastic elastomer under the condition of a lower temperature (−30 °C), may be at least 56 kJ/m², at least 57 kJ/m², at least 58 kJ/m², at least 59 kJ/m², or at least 60 kJ/m². When the above range is satisfied, the composition of thermoplastic elastomer may be evaluated as having an excellent impact strength.

According to an embodiment of the present disclosure, the shrinkage rate, which was measured for the composition of thermoplastic elastomer, in an MD direction in compliance with ISO 294 may be at least 0.7%. Specifically, the shrinkage rate may be at most 0.68%, at most 0.66%, at most 0.64%, at most 0.62%, or at most 0.6%. When the above range is satisfied, the composition of thermoplastic elastomer may be evaluated as being stably maintained in dimension thereof, as the composition of thermoplastic elastomer exhibits the lower shrinkage rate.

Hereinafter, components of the composition of thermoplastic elastomer according to an embodiment of the present disclosure will be described in detail.

### Polypropylene Resin

The composition of thermoplastic elastomer according to an embodiment of the present disclosure may include polypropylene resin, and the polypropylene resin may impart heat resistance and moldability to the composition of thermoplastic elastomer.

According to an embodiment of the present disclosure, the polypropylene resin may include a single polymer or a copolymer. The polypropylene resin may be a single polymer of a propylene monomer. Alternatively, the polypropylene resin may include at least one single polymer selected from the group consisting of 1-butene, 1-pentene, 1-hexene, 1-hexene, 1-heptene and 1-oxene, and a copolymer of the polypropylene resin.

According to an embodiment of the present disclosure, the composition of thermoplastic elastomer may include polypropylene resin ranging from 40 wt % to 70 wt %. Specifically, the composition of thermoplastic elastomer may include polypropylene resin of at least 42 wt %, at least 44 wt %, at least 46 wt %, at least 48 wt %, or at least 50 wt %, and may include polypropylene resin of at most 68 wt %, at most 66 wt %, at most 64 wt %, at most 62 wt %, or at most 60 wt %. When the above-described range is satisfied, the heat resistance and moldability of the composition of thermoplastic elastomer may be improved.

According to an embodiment of the present disclosure, the polypropylene resin may include first polypropylene resin having a melt index, which was measured under the condition of 230 °C and a 2.16 kg load in compliance with ASTM D1238 to have the range from 5 g/10 min to 40 g/10 min, and second polypropylene resin having a melt index, which was measured under the condition of 230 °C and a 2.16 kg load in compliance with ASTM D1238 to have the range from 50 g/10 min to 80 g/10 min.

According to an embodiment of the present disclosure, the composition of thermoplastic elastomer may include the first polypropylene resin ranging from 40 wt % to 70 wt %, and the second polypropylene resin ranging from 0 wt % to 20 wt %.

According to an embodiment of the present disclosure, when the composition of thermoplastic elastomer may include the first polypropylene resin and the second polypropylene resin, the composition of thermoplastic elastomer may include the first polypropylene resin of at least 42 wt %, at least 44 wt %, at least 46 wt %, at least 48 wt %, or at least 50 wt %, and at most 68 wt %, at most 66 wt %, at most 64 wt %, at most 62 wt %, or at most 60 wt %. In addition, when the composition of thermoplastic elastomer includes the second polypropylene resin of at least 2 wt %, at least 4 wt %, at least 6 wt %, at least 8 wt %, or at least 10 wt %, and at most 19 wt %, at most 18 wt %, at most 17 wt %, at most 16 wt %, or at most 15 wt %. When the above-described range is satisfied, the melt index of the composition of thermoplastic elastomer may be improved.

### Olefin-Based Block Copolymer

According to an embodiment of the present disclosure, the composition of thermoplastic elastomer may include an olefin-based block copolymer. The olefin-based block copolymer may impart a mechanical property to the composition of thermoplastic elastomer.

According to an embodiment of the present disclosure, the olefin-based block copolymer may be a block copolymer including ethylene and alpha-olefin polymers. The alpha-olefin may have 4 to 10 carbon atoms and a carbon-carbon double bond at the terminal position thereof. Specifically, the alpha-olefin may include at least one type selected from the group consisting of ethylene, 1-butene, 3-methyl-1-butene, 1-pentene, 4-methyl-1-pentene, 3-methyl-1-pentene, and 1-hexene.

According to an embodiment of the present disclosure, the melt index, which was measured for the olefin-based block copolymer under the condition of 190 °C, and a 2.16 kg load in compliance with ASTM D1238, may range from 0.2 g/10 min to 10 g/10 min. Specifically, the melt index measured for the olefin-based block copolymer may be at least 0.25 g/10 min, 0.3 g/10 min, 0.35 g/10 min, 0.4 g/10 min, 0.45 g/10 min, or 0.5 g/10 min, and may also be at most 9 g/10 min, 8 g/10 min, 7 g/10 min, 6 g/10 min, or 5 g/10 min. When the above range is satisfied, the composition of thermoplastic elastomer may have the impact strength improved and a lower shrinkage rate.

According to an embodiment of the present disclosure, the olefin-based block copolymer may have the density of at most 0.87 g/cm³. Specifically, the density of the olefin-based block copolymer may be at most 0.868 g/cm³, 0.866 g/cm³, 0.864 g/cm³, 0.862 g/cm³, or 0.86 g/cm³. When the above range is satisfied, the composition of thermoplastic elastomer may have the impact strength improved and a lower shrinkage rate.

According to an embodiment of the present disclosure, the composition of thermoplastic elastomer may include the olefin-based block copolymer ranging from 15 wt % to 50 wt %. Specifically, the composition of thermoplastic elastomer may include the olefin-based block copolymer of at least 16 wt %, at least 17 wt %, at least 18 wt %, at least 19 wt %, or at least 20 wt %, and at most 48 wt %, at most 46 wt %, at most 44 wt %, at most 42 wt %, or at most 40 wt % When the above range is satisfied, the composition of thermoplastic elastomer may be evaluated as having the excellent impact strength and the lower shrinkage rate.

### Polyolefin Plastomer

The composition of thermoplastic elastomer according to an embodiment of the present disclosure may include polyolefin plastomer, and polyolefin plastomer may reduce the shrinkage rate of the composition of thermoplastic elastomer.

According to an embodiment of the present disclosure, the polyolefin plastomer may be produced through gas-phase polymerization, and may include at least one type selected from the group consisting of polyethylene resin (m-PE), polyethylene octene copolymer plastomer (m-PEOP), polyethylenehexene copolymer plastomer (m-PEHP), polyethylene butene copolymer plastomer (m-PEBP), polyethylene acrylic acid copolymer resin (EEAc), polyethylene ethyl acrylate copolymer resin (EEA), polyethylene butyl acrylate copolymer resin (EBA), polypropylene ethylene copolymer plastomer (m-PEPP), polypropylene octene copolymer plastomer (m-POPP), polypropylene hexene copolymer plastomer (m-PHPP), and polypropylene-butene copolymer plastomer (m-PBPP). As the polyolefin plastomer may be produced through gas-phase polymerization, a higher-density portion and a lower-density portion of the polyolefin plastomer are formed in multiple layers to form an enveloped structure. The polyolefin plastomer may have a smaller amount of volatile organic compounds (VOCs), when compared to polyolefin plastomers produced through liquid-phase polymerization such as a metallocene catalyst process.

According to an embodiment of the present disclosure, the polyolefin plastomer may have the density of at least 0.885 g/cm³. Specifically, the density may be at least 0.885 g/cm³ or at least 0.90 g/cm³. When the above range is satisfied, the polyolefin plastomer may have more excellent compatibility with the polypropylene resin an improved improved in low-temperature impact strength.

According to an embodiment of the present disclosure, the melt index, which was measured for the polyolefin plastomer under the conditions of 230 °C, and a 2.16 kg load in compliance with ASTM D1238, may range from 0.5 g/10 min to 8 g/10 min. Specifically, the melt index may be at least 0.6 g/10 min, at least 0.7 g/10 min, at least 0.8 g/10 min, at least 0.9 g/10 min, or at least 1 g/10 min, and may also be at most 7.5 g/10 min, at most 7 g/10 min, at most 6.5 g/10 min, at most 6 g/10 min, at most 5.5 g/10 min, or at most 5 g/10 min When the above range is satisfied, the polyolefin plastomer may have more excellent compatibility with the polypropylene resin, and may be more improved in low-temperature impact strength.

According to an embodiment of the present disclosure, the composition of thermoplastic elastomer may include the polyolefin plastomer ranging from 5 wt % to 30 wt %. Specifically, the polyolefin plastomer may be at least 6 wt %, at least 7 wt %, at least 8 wt %, at least 9 wt %, or at least 10 wt %, and may also be at most 38 wt %, at most 36 wt %, at most 34 wt %, at most 32 wt %, or at most 30 wt %. When the above-described range is satisfied, the shrinkage rate of the composition of thermoplastic elastomer may be lowered. When the above range exceeds, the lower-temperature impact strength of the composition of thermoplastic elastomer may be lowered.

According to an embodiment of the present disclosure, in the composition of thermoplastic elastomer, the total content of the olefin block copolymer and the polyolefin plastomer may range from 30 wt % to 60 wt %. Specifically, the total content of the olefin block copolymer and the polyolefin plastomer may be at least 32 wt %, at least 34 wt %, at least 36 wt %, at least 38 wt %, or at least 40 wt %, and may include at most 58 wt %, at most 56 wt %, at most 54 wt %, at most 52 wt %, or at most 50 wt %. When the above-range is satisfied, the composition of thermoplastic elastomer may be improved in the lower-temperature impact strength and the processability.

### Other Additives

According to an embodiment of the present disclosure, the composition of thermoplastic elastomer may additionally include a lubricant, an antioxidant, a light stabilizer, a release agent, an antistatic agent, a crosslinking agent, an antibacterial agent, a processing aid, a metal inactivator, a friction wear resistance, or a coupling agent if necessary, in addition to the polypropylene resin, the olefin block copolymer, and the polyolefin plastomer.

### <Molded Product>

The present disclosure provides a molded product from the composition of thermoplastic elastomer.

According to an embodiment of the present disclosure, the molded product may be extrusion and injection-molded from the composition of thermoplastic elastomer. The molded product may be applied to a product group requiring an excellent property in mechanical property, heat resistance and dimensional stability. Specifically, the product group may be airbag chutes.

In general, a chute, which is a device to fix the passenger airbag, has a space to receive an airbag, which is folded. In addition, a door is provided in an opening part of the chute to be open when the airbag is inflated, and a scrim is interposed between the chute and the door to couple one side of the chute to a door part, such that the door part is pivoted. As the scrim is applied, the mechanical strength of the chute at a lower temperature and a higher temperature may be complemented, as the scrim is applied. Accordingly, the content of elastomer necessary to increase the lower-temperature impact may be reduced. Accordingly, there is an issue to lower the dimensional stability of the chute. Meanwhile, the elastomer may be an olefin block copolymer according to an embodiment of the present disclosure.

According to an embodiment of the present disclosure, when the chute is molded using the composition of thermoplastic elastomer, even if the content of the elastomer in the chute is reduced, excellent shrinkage stability may be exhibited. Accordingly, the quality improved may be exhibited in the process of evaluating the airbag fusion and the deployment of the airbag.

Hereinafter, an embodiment of the present disclosure will be described in detail such that those skilled in the art may easily reproduce the embodiment of the present disclosure. However, the inventive concept may be implemented in various forms and is limited to embodiments described herein.

### INVENTIVE EXAMPLES AND COMPARATIVE EXAMPLES

Materials employed in inventive examples and comparative examples are as follows.
First polypropylene resin (A-1): a polypropylene resin (produced by LyondellBasell; product name: Moplen EP300R) was employed with the density of 0.90 g/cm³, the melt index, which was measured under the conditions of 230 °C, and a 2.16 kg load in compliance with ASTM D1238 and shown as 30 g/10 min, and flexural modulus of 1050 MPa.
First polypropylene resin (A-2): a polypropylene resin (produced by SK Geocentric; product name: Yuplene BX3500) was employed with the density of 0.90 g/cm³, the melt index, which was measured under the conditions of 230 °C, and a 2.16 kg load in compliance with ASTM D1238 and shown as 10 g/10 min, and flexural modulus of 1716 MPa.
First polypropylene resin (A-3): a polypropylene resin (produced by SK Geocentric; product name: Yuplene BX3800) was employed with the density of 0.90 g/cm³, the melt index, which was measured under the conditions of 230 °C, and a 2.16 kg load in compliance with ASTM D1238 and shown as 30 g/10 min, and flexural modulus of 1765 MPa.
Second polypropylene resin (A-4): a polypropylene resin (produced by SK Geocentric; product name: Yuplene BM3900) was employed with the density of 0.90 g/cm³, the melt index, which was measured under the conditions of 230 °C, and a 2.16 kg load in compliance with ASTM D1238 and shown as 60 g/10 min, and flexural modulus of 1422 MPa.
Olefin block copolymer (B-1): an olefin block copolymer (produced by DOW; product name: ENGAGE™ 11547) was employed with the density of 0.87 g/cm³, the melt index, which was measured under the conditions of 190 °C, and a 2.16 kg load in compliance with ASTM D1238 and shown as 0.5 g/10 min.
Olefin block copolymer (B-2): an olefin block copolymer (produced by DOW; product name: ENGAGE™ XLT 8677) was employed with the density of 0.87 g/cm³, the melt index, which was measured under the conditions of 190 °C, and a 2.16 kg load in compliance with ASTM D1238 and shown as 5 g/10 min.
Polyolefin plastomer (C-1): a polyolefin plastomer (produced by DL Chemical; product name: VL8801) produced through the gas-phase polymerization was employed with the melt index, which was measured under the conditions of 190 °C, and a 2.16 kg load in compliance with ASTM D1238 and shown as 1 g/10 min, and the density of 0.885 g/cm³.
Polyolefin plastomer (C-2): a polyolefin plastomer (produced by DL Chemical; product name: VL8803) produced through the gas-phase polymerization was employed with the melt index, which was measured under the conditions of 190 °C, and a 2.16 kg load in compliance with ASTM D1238 and shown as 3 g/10 min, and the density of 0.885 g/cm³.

The first polypropylene resin, the second polypropylene resin, the olefin block copolymer, and the polyolefin plastomer were mixed in content described in following Tables 1 and 2 to prepare the composition of thermoplastic elastomer.

### EXPERIMENTAL EXAMPLE

The melt index, the tensile strength, the tensile elongation, the flexural strength, the flexural modulus, or the impact strength, a heat deflection temperature, and a shrinkage rate were measured with respect to each composition of thermoplastic elastomer according to the Inventive examples and the Comparative examples and shown in following Tables 1 and 2.
Melt index (g/10 min): was measured under the condition of 230 °C, and a 2.16 kg load in compliance with ISO 1133.
Tensile strength (MPa) and tensile elongation (%): were measured under the condition of the tensile speed of 50 mm/min in compliance with ISO 527.
Flexural strength (MPa) and flexural modulus (MPa): were measured under the condition of the flexural test speed of 2 mm/min in compliance with ISO 178.
Impact strength (KJ/m²): was measured under the environments of a normal temperature (25 °C) and a lower temperature (−30 °C) through the IZOD manner in compliance with ISO 179.
Heat Deflection Temperature (°C): was measured under the condition of a 0.45 MPa load in compliance with ISO 75.
Shrinkage rate (%): was measured in the MD direction in compliance with ISO 294.

TABLE 1

| | | | Inventive examples | | | |
|---|---|---|---|---|---|---|
| | | | 1 | 2 | 3 | 4 |
| First polypropylene resin | | Type | (A-1) | (A-1) | (A-1) | (A-1) |
| | | wt % | 50 | 50 | 50 | 50 |
| Second polypropylene resin | | wt % | 10 | 10 | 10 | 10 |
| Olefin block copolymer | | Type | (B-1) | (B-2) | (B-1) | (B-2) |
| | | wt % | 20 | 20 | 20 | 20 |
| Polyolefin plastomer | | Type | (C-1) | (C-1) | (C-2) | (C-2) |
| | | wt % | 20 | 20 | 20 | 20 |
| Composition | Melt index (g/10 min) | | 13.8 | 15.6 | 15.2 | 21.6 |
| of | Tensile strength (MPa) | | 18.6 | 13.7 | 17.2 | 14.9 |
| thermoplastic | Tensile elongation (5) | | 725 | 489 | 742 | 642 |
| elastomer | Flexural strength (MPa) | | 12.2 | 13.2 | 11.5 | 13.4 |
| | Flexural strength (MPa) | | 402 | 552 | 402 | 502 |
| | Impact | Normal | 57.4 | 53.9 | 55.4 | 53.6 |
| | strength | temperature | | | | |
| | (KJ/m²) | Lower | 67.3 | 60.2 | 62.8 | 65.6 |
| | | temperature | | | | |

| | | | | |
|---|---|---|---|---|
| Heat deflection | 62.7 | 61.9 | 59.8 | 61.5 |
| temperature (°C) | | | | |
| Shrinkage rate(%) | 0.60 | 0.47 | 0.56 | 0.44 |

TABLE 2

| | | | Comparative examples | | | | | |
|---|---|---|---|---|---|---|---|---|
| | | | 1 | 2 | 3 | 4 | 5 | 6 |
| First polypropylene resin | | Type | (A-3) | (A-1) | (A-2) | (A-2) | (A-3) | (A-3) |
| | | wt % | 70 | 30 | 57 | 57 | 57 | 57 |
| Second polypropylene resin | | wt % | — | 30 | — | — | — | — |
| olefin block copolymer | | Type | — | (B-1) | (B-1) | (B-2) | (B-1) | (B-2) |
| | | wt % | 14 | 40 | 43 | 43 | 43 | 43 |
| Polyolefin plastomer | | Type | (C-2) | — | — | — | — | — |
| | | wt % | 14 | — | — | — | — | — |
| Composition | Melt index (g/10 min) | | 13.5 | 14.4 | 3.9 | 9.6 | 9.7 | 15.6 |
| of | Tensile strength (MPa) | | 15.5 | 13.1 | 15.3 | 14.5 | 13.7 | 12.4 |
| thermoplastic | Tensile elongation (5) | | 350 | 498 | 428 | 363 | 441 | 374 |
| elastomer | Flexural strength (MPa) | | 17.3 | 10.8 | 10.9 | 12.6 | 10.5 | 12.8 |
| | Flexural strength (MPa) | | 640 | 403 | 403 | 552 | 355 | 502 |
| | Impact | Normal | 58 | 61.8 | 60.9 | 55.5 | 54.8 | 53.6 |
| | strength | temperature | | | | | | |
| | (KJ/m²) | Lower | 13 | 69.5 | 64.2 | 68.7 | 60.7 | 65.6 |
| | | temperature | | | | | | |

| | | | | | | |
|---|---|---|---|---|---|---|
| Heat deflection | 67.5 | 58.0 | 60.2 | 65.7 | 62.1 | 67.6 |
| temperature (°C) | | | | | | |
| Shrinkage rate(%) | 1.2 | 0.83 | 0.93 | 0.54 | 0.96 | 0.55 |

Referring to Tables 1 and 2, it may be recognized that Inventive examples 1 to 4 including polypropylene resin, an olefin block copolymer, and a polyolefin plastomer in preferred contents satisfied the conditions of the excellent melt index and the excellent the tensile property while exhibiting a lower shrinkage rate of at most 0.7%.

In addition, it may be recognized that Inventive example 1 employing the olefin block copolymer and the polyolefin plastomer having the lower melt index was more improved in the tensile property and the impact strength when compared to Inventive examples 2 to 4.

Meanwhile, it may be recognized that Comparative example 1 employing a polyolefin plastomer in content less than a preferred content exhibited more than 0.7% in the shrinkage rate, even though the conditions of the excellent melt index and the excellent tensile property were satisfied.

In addition, it may be recognized that Comparative examples 2 to 6 without the polyolefin plastomer exhibited more than 0.7% in the shrinkage rate, even though the conditions of the excellent melt index and the excellent tensile property were satisfied. In addition, in Comparative examples 2 to 6, even if the shrinkage rate is at most 0.7%, the inferior melt index and the inferior tensile strength were exhibited.

According to an embodiment of the present disclosure, the composition of thermoplastic elastomer may satisfy all of the excellent melt index, the excellent tensile property, and the excellent impact strength, while exhibiting the lower shrinkage rate.

According to an embodiment of the present disclosure, the chute of the airbag may include the composition of thermoplastic elastomer which satisfies all of the excellent melt index, the excellent tensile property, and the excellent impact strength, while exhibiting the lower shrinkage rate, thereby exhibiting improved quality in evaluating for the fusion and the deployment of the airbag.

Hereinabove, although the present disclosure has been described with reference to exemplary embodiments and the accompanying drawings, the present disclosure is not limited thereto but may be variously modified and altered by those skilled in the art to which the present disclosure pertains without departing from the spirit and scope of the present disclosure claimed in the following claims.

What is claimed is:

1. A thermoplastic elastomer composition comprising:
a polypropylene resin in an amount ranging from 40 wt % to 70 wt %;
an olefin block copolymer in an amount ranging from 15 wt % to 50 wt %; and
a polyolefin plastomer in an amount ranging from 5 wt % to 30 wt %.

2. The composition of claim 1, wherein the polypropylene resin comprises:
first polypropylene resin having a melt index ranging from 5 g/10 min to 40 g/10 min, measured at 230 °C under a 2.16 kg load; and
second polypropylene resin having a melt index, ranging from 50 g/10 min to 80 g/10 min, measured at 230 °C under a 2.16 kg load.

3. The composition of claim 2, wherein the first polypropylene resin is present in an amount ranging from 40 wt % to 70 wt %, and
wherein the second polypropylene resin is present in an amount ranging from 0 wt % to 20 wt %.

4. The composition of claim 1, wherein the olefin block copolymer has a melt index ranging from 0.5 g/10 min to 5 g/10 min, measured at 190 °C under a 2.16 kg load.

5. The composition of claim 1, wherein the olefin block copolymer has a density of at most 0.87 g/cm³.

6. The composition of claim 1, wherein the olefin block copolymer comprises ethylene and alpha-olefin polymers.

7. The composition of claim 6, wherein the alpha-olefin has 4 to 10 carbon atoms.

8. The composition of claim 1, wherein the polyolefin plastomer has a density of at least 0.885 g/cm³.

9. The composition of claim 1, wherein the polyolefin plastomer has a melt index ranging from 0.5 g/10 min to 8 g/10 min, measured at 230 °C under a 2.16 kg load.

10. The composition of claim 1, wherein the polyolefin plastomer is produced by gas-phase polymerization.

11. The composition of claim 1, wherein the olefin block copolymer and the polyolefin plastomer are present in an amount ranging from 30 wt % to 60 wt %.

12. An airbag chute comprising the thermoplastic elastomer of claim 1.

13. A thermoplastic elastomer composition comprising:
a first polypropylene resin in an amount ranging from 40 wt % to 70 wt % and having a melt index ranging from 5 g/10 min to 40 g/10 min, measured at 230 °C under a 2.16 kg load;
a second polypropylene resin in an amount ranging from 1 wt % to 20 wt % and having a melt index ranging from 50 g/10 min to 80 g/10 min, measured at 230 °C under a 2.16 kg load;
an olefin block copolymer in an amount ranging from 15 wt % to 50 wt % having a density of at most 0.87 g/cm³; and
a polyolefin plastomer in an amount ranging from 5 wt % to 30 wt % and having a density of at least 0.885 g/cm³,
wherein the olefin block copolymer and the polyolefin plastomer are present in an amount ranging from 30 wt % to 60 wt %.

14. The composition of claim 13, wherein the olefin block copolymer has a melt index ranging from 0.5 g/10 min to 5 g/10 min, measured at 190 °C under a 2.16 kg load.

15. The composition of claim 13, wherein the polyolefin plastomer has a melt index ranging from 0.5 g/10 min to 5 g/10 min, measured at 190 °C under a 2.16 kg load.

16. The composition of claim 13, wherein the polyolefin plastomer is produced by gas-phase polymerization.

17. The composition of claim 13, wherein the olefin block copolymer is a copolymer of ethylene and an alpha-olefin.

18. The composition of claim 17, wherein the alpha-olefin has 4-10 carbon atoms.

19. The composition of claim 13, wherein the first polypropylene resin is present in an amount from 45 wt % to 65 wt %.

20. The composition of claim 13, wherein the second polypropylene resin is present in an amount from 5 wt % to 15 wt %.
